(19) United States
(12) Patent Application Publication
(10) Pub. No.: US 2007/0103267 A1
(43) Pub. Date: May 10, 2007

(54) Power feed system for ring sensor

(75) Inventor: Yutaka Okada, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/593,497

(22) Filed: Nov. 7, 2006

(30) Foreign Application Priority Data
Nov. 8, 2005 (JP) 2005-323099

(51) Int. Cl. H01F 27/06

(52) U.S. Cl. 336/65; 363/37

(57) ABSTRACT

On a power-feeding unit for converting electric power derived from a power supply into magnetic fluxes, a ring sensor as power-fed unit is placed, so that power is fed from the power-feeding unit to the ring sensor by electromagnetic induction. With this structure, electrical contacts are eliminated, and a waterproof structure is fulfilled. Also, a secondary coil and a core are placed at generally symmetrical positions with respect to a center of the ring sensor, by which a uniform weight balance is obtained.

### CROSS-REFERENCE TO RELATED APPLICATIONS

This nonprovisional application claims priority under 35 U.S.C. §119(a) on Patent Application No(s). 2005-323099 filed in Japan on Nov. 8, 2005, the entire contents of which are hereby incorporated by reference.

### BACKGROUND OF THE INVENTION

The present invention relates to a power feed system for ring-shaped cordless equipment, preferably, a ring sensor to be used for noninvasive optical measurement of living body's pulses or sphygmus.

A pulse wave sensor by a prior art includes a housing section which is provided in a ring type for containing a circuit part or batteries, a detection section for detecting pulse information about a human body, and a fixing member for fixing those sections to a finger, where the circuit section and the detection section are electrically connected to each other flexibly by flexible board. As the fixing member, closed, ring-shaped ones or horseshoe clip-shaped ones provided at one end of the housing section are proposed (see, e.g., JP 2001-70264 A).

The detection section, which includes a light-receiving part and a light-emitting part, is so structured that light emitted from the light-emitting part, upon impinging on blood vessels of a finger, is absorbed by hemoglobin in the blood flowing through the vessels while the rest of the light is transmitted to reach the light-receiving part so as to be converted into an electric signal.

On condition that such a detection section is pressed against the finger so that a specified pressure is preliminarily imparted to the blood vessels, the light amount received by the light-receiving part decreases during vasodilatation periods due to pulses, and increases during vasoconstriction periods. Thus, since the light amount is periodically modulated by pulses during light passage through blood vessels, the pulse rate can be known by measuring the period of amplitude changes of a signal outputted by the light-receiving part.

Also, as a means for feeding power to a load in a noncontact manner, a method by electromagnetic induction is known. FIGS. 8A and 8B are a circuit block diagram and a power transmission part sectional view, respectively of electrical equipment to which the noncontact power feed means by electromagnetic induction is applied.

In FIGS. 8A and 8B, on a power-feeding unit 518 connected to a power supply, a power-fed unit 501 having a load is mounted so as to be inseparable from each other. The power-feeding unit 518, which includes a primary coil 510 connected to an oscillation circuit, generates magnetic fluxes. The power-fed unit 501, which includes a secondary coil 502, receives the magnetic fluxes generated by the primary coil 510, converts them into electric power, and feeds the power to the load.

The primary coil 510 contained in the power-feeding unit 518 and the secondary coil 502 contained in the power-fed unit 501 are paired as a set in contact with each other to form a transformer so that electric power is transferred from the power-feeding unit 518 to the power-fed unit 501. In many cases, the coils are wound each around a core made of a magnetic material, by which the coupling between the primary coil and the secondary coil is enhanced. As products using such a noncontact power feeding means, there have been commercially available electric toothbrushes and the like.

A pulse wave sensor is required to be waterproof. For example, for the interior of a bathroom, which involves hard temperature changes so that the risk of blood pressure elevation is increased, it is strongly desired to wear the pulse wave sensor during bathing. Indeed making the housing section provided in a closed structure is one way to provide a waterproof means, but time and labor for battery replacement is troublesome, and moreover repeated opening and closing of the housing section might cause the seal to wear so that the waterproofness might be impaired.

Another means is that electrical contact for charging is provided so as to be exposed from the housing section, but this could cause electrical contact failures due to corrosion. A means for solving these problems could be a noncontact power feeding means by electromagnetic induction, such as shown in the background art. In this case, a structure in which the secondary coil and the core are housed in the housing section is easily conceivable, but the coils and the core are larger in size and weight so that the ring appearance would be impaired, and moreover a poor weight balance would impair the fitness of use.

### SUMMARY OF THE INVENTION

In view of the above-described problems, an object of the present invention is to provide a ring sensor which is small in size, but successful in weight balance and high in waterproofness.

In order to achieve the above object there is provided a power feed system for feeding power by electromagnetic coupling of a primary coil of a power-feeding unit and a secondary coil of a power-fed unit, wherein the power feed system is a noncontact power feed system in which the power-feeding unit and the power-fed unit are separable from each other, and the power-feeding unit includes a power-feeding side core which is composed so as to be separable.

In one embodiment, the power-feeding side core comprises: a cylindrical portion which has an opening at its one end and which is formed into a bottomed cylindrical shape larger than an outer diameter of the primary coil; a center core protruding at a bottom-portion center of the cylindrical portion, and a lid portion for closing the opening, wherein the primary coil is wound so as to be concentric with the center core, and the secondary coil is inserted into the center core so that when the opening is closed by the lid portion, a closed magnetic circuit is formed.

In one embodiment, the outer diameter of the center core decreases with increasing nearness to the opening so as to exhibit a truncated-cone shape.

In one embodiment, a pillar protrudes at a generally central portion of the lid portion, the pillar being fitted to the opening, and an outer circumferential surface of the pillar is brought into contact with an inner circumferential surface of the opening.

In one embodiment, a recessed portion is provided at a generally central portion of the pillar, the recessed portion being fitted to an end portion of the center core, and an inner circumferential surface of the recessed portion is brought into contact with the outer circumferential surface of the center core.

In one embodiment, the power-feeding side core comprises a cylindrical portion which has an opening at its one end and which is formed into a bottomed cylindrical shape larger than an outer diameter of the primary coil, a center core protrudes at a bottom-portion center of the cylindrical portion, and a lid portion for closing the opening, wherein the primary coil is wound so as to be concentric with the center core, the power-fed unit is placed on an opening-side end face of the center core, and when the opening is closed by the lid portion, a closed magnetic circuit is formed.

In one embodiment, a pillar protrudes at a generally central portion of the lid portion, the pillar being fitted to the opening, and an outer circumferential surface of the pillar is brought into contact with an inner circumferential surface of the opening.

In one embodiment, a sum of a height of the center core and a thickness of the power-fed unit is smaller than an inner-wall height of the cylindrical portion, and a sum of the height of the center core, the thickness of the power-fed unit and a height of the pillar is equal to or larger than the inner-wall height of the cylindrical portion.

In one embodiment, the power feed system further comprises a fitting portion which allows the secondary coil to be accommodated and placed within an end face region of the center core.

In one embodiment, the power-fed unit includes a ring-shaped casing, and at a generally central portion of at least either one of the center core or the pillar, a hollow portion whose diameter is smaller than an inner diameter of the secondary coil is provided.

In one embodiment, the power-feeding side core comprises a rectangular-cylindrical portion having a placement plane divided into first and second placement planes by a gap, and a lid portion to be placed on the power-fed unit placed on the placement plane, and wherein the primary coil is wound around the gap, the power-fed unit includes a power-fed side core, the power-fed side core is divided into first and second cores by a discontinuous portion, the first and second cores are placed in contact on the first and second placement planes, respectively, and when the first and second cores are bridged by the lid portion, a closed magnetic circuit is formed.

In one embodiment, a distance of the gap is smaller than a distance of the discontinuous portion.

In one embodiment, a fitting portion at which the placement plane and the power-fed unit are to be fitted to each other is further included so that the gap and the discontinuous portion become generally coincident in position with each other.

Also, there is provided a power-fed unit comprising: a continuous or discontinuous ring-shaped casing; and a power-fed side core made of a ring-shaped magnetic material having a ring-shaped continuous secondary coil within the casing or a discontinuous portion, and a secondary coil wound along an outer configuration of the power-fed side core.

In one embodiment, the power-fed side core is flexible.

In one embodiment, the power-fed side core is formed by stacking thin sheets of a magnetic material into multiple layers.

In one embodiment, the power-fed side core is molded by dispersing magnetic powder into resin.

In one embodiment, the secondary coil is composed of a plurality of coils in combination.

In one embodiment, the secondary coils are connected so as to feed power to loads independent of one another, respectively.

In one embodiment, a flexible board is connected to the secondary coil.

In one embodiment, the entire secondary coil is formed from a flexible board.

In one embodiment, the flexible board includes a plurality of conductors placed generally parallel to the flexible board, the conductors extend from one end to the other of the flexible board, and one end of one conductor and the other end of the other conductor are electrically connected to each other, by which the secondary coil is formed.

In one embodiment, there is provided a noncontact power feed system which is enabled to feed power in a state that the above power-fed unit is placed on the above power-feeding unit.

In one embodiment, there is provided a ring sensor on which the above power-fed unit is mounted.

In one embodiment, there is provided a ring sensor in which the above ring sensor is combined with the above power-feeding unit.

According to the sensor of the present invention, since the ring sensor can be fed with power in a noncontact manner, there is no need for electrical contact for charging use, making it practicable to fulfill a waterproof structure. Also, the time and labor for battery replacement is no longer required, and only setting the ring sensor on the charging device allows the charging to be fulfilled, hence a high convenience. Further, when the secondary coil and the core are placed at generally symmetrical positions with respect to the center of the ring, a uniform weight balance can be obtained so that a good feeling of fitness can be obtained. Furthermore, by virtue of a closed magnetic circuit formed by the core, less leakage fluxes occur and a high electric power transmission efficiency is achieved.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIGS. 1A to 1C are sectional views and a circuit diagram of a ring sensor according to a first embodiment of the present invention;

FIGS. 2A and 2B are sectional views of a power transmission part of a power-feeding unit according to the first embodiment of the invention;

FIGS. 3A and 3B are sectional views of a ring sensor according to a second embodiment of the present invention;

FIGS. 4A and 4B are sectional views of a power transmission part of a power-feeding unit according to the second embodiment of the invention;

FIGS. 5A to 5C are sectional views and a circuit diagram of a ring sensor according to a third embodiment of the present invention;

FIGS. 6A and 6B are sectional views of a power transmission part of a power-feeding unit according to the third embodiment of the invention;

FIGS. 7A and 7B are a perspective view in which a flexible board is provided around the core of a ring sensor and a plan view of the flexible board according to a fourth embodiment of the invention, respectively; and

FIGS. 8A and 8B are a circuit block diagram of a noncontact power feeding means and a sectional view of the power transmission part according to a prior art, respectively.

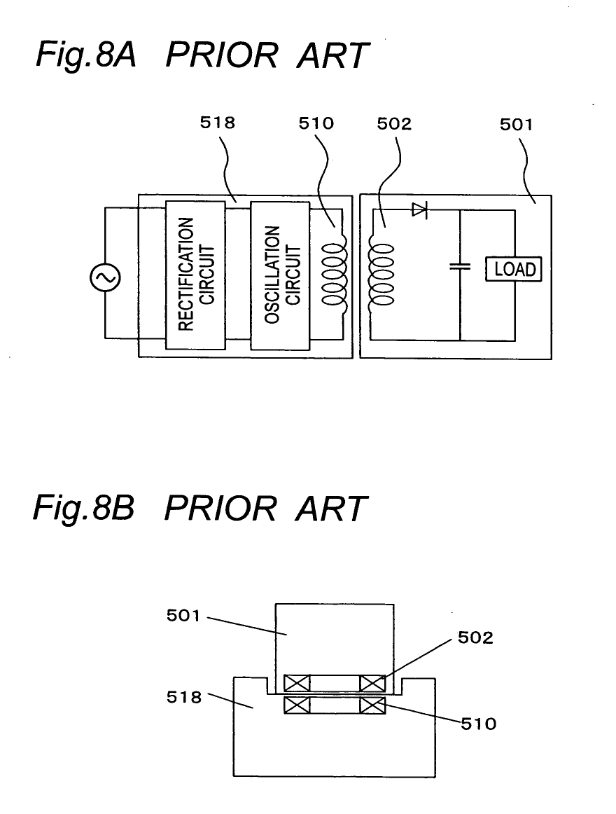

### DETAILED DESCRIPTION OF THE INVENTION

### Embodiment 1

Hereinbelow, embodiments of the present invention will be described with reference to the accompanying drawings.

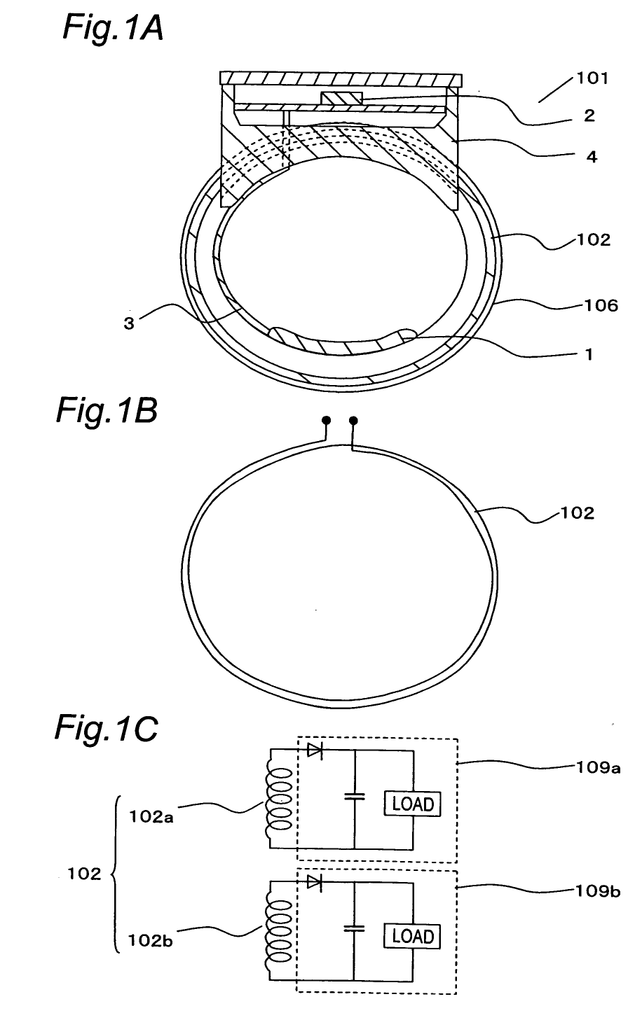

FIG. 1A is a sectional view of a ring sensor according to Embodiment 1. FIG. 1B is a sectional view in which only a secondary coil of the ring sensor is shown. FIG. 1C is a circuit diagram in a case where a plurality of secondary coils are provided.

The ring sensor 101, which is a power-fed unit, is made up of a ring-shaped belt 106, and a housing section 4 provided on the outer periphery of the belt 106, where the belt 106 has a closed ring shape suitable for insertion of a finger.

On the inner circumferential surface of the ring is provided a detection section 1 including a light-receiving part as a sensor and a light-emitting part.

A circuit section 2 is housed in the housing section 4. The detection section 1 and the circuit section 2 are electrically connected to each other by a flexible board 3.

The ring-shaped belt 106 contains, between its outer circumferential surface and inner circumferential surface, a secondary coil 102 in which a conductive wire is wound around so as to be concentric with the ring. This secondary coil 102 is electrically connected to the circuit section 2, which is a load, to serve for charging of a battery (not shown) connected to the circuit section 2.

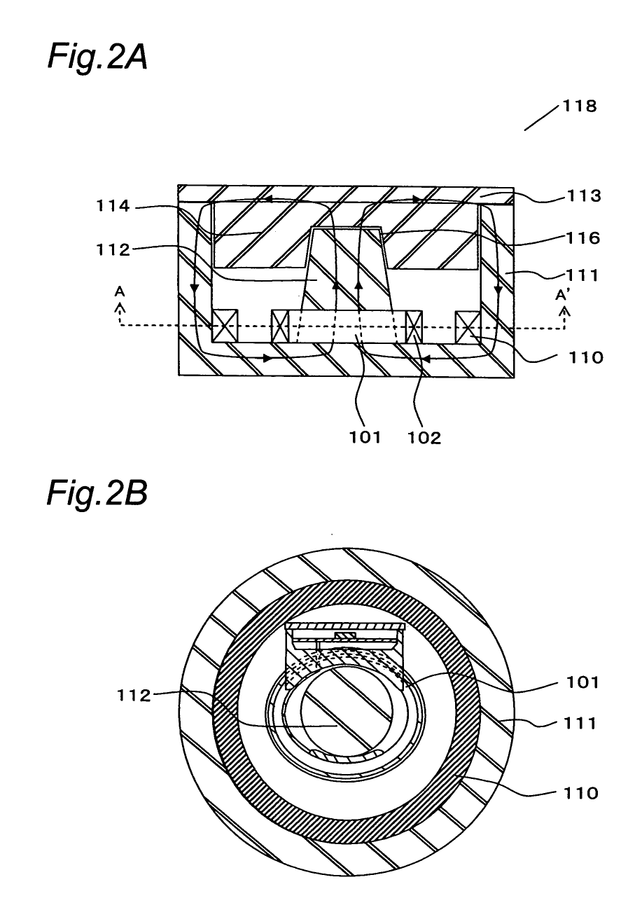

FIG. 2A is a sectional view of a power transmission part of a power-feeding unit 118 for feeding power to the battery of the ring sensor 101 according to Embodiment 1. FIG. 2B is a sectional view taken along the line A-A′ of FIG. 2A.

The power transmission part of the power-feeding unit 118 is composed of a feeding-side core, and a primary coil 110 wound around the feeding-side core.

The feeding-side core is composed of a cylindrical portion 111 which is made of a ferrite or other magnetic material and which has one end opened and which is formed into a bottomed cylindrical shape, a center core 112 protruding at a bottom-portion center of the cylindrical portion 111, a lid portion 113 which closes the opening, and a pillar 114 protruding at a generally central portion of the lid portion 113.

The center core 112 is formed into such a truncated-cone shape that its outer diameter decreases with increasing nearness to the opening.

Also, the pillar 114 is fitted to the opening of the cylindrical portion 111, and has its outer circumferential surface brought into contact with the inner circumferential surface of the cylindrical portion 111.

Also, a recessed portion 116 which is to be fitted to an upper end portion of the center core 112 is provided at a generally central portion of the pillar 114. The inner surface of the recessed portion 116 is brought into contact with the wall surface of the center core 112.

The primary coil 110 is wound along inner circumferential surface at the bottom of the cylindrical portion 111 so as to be concentric with the center core 112.

In the power-feeding unit 118 constructed as shown above, the ring sensor 101 is inserted through the center core 112, and the opening of the cylindrical portion 111 is closed by setting the lid portion 113 thereon. Thus, a closed magnetic circuit such as indicated by arrow in the figure is formed, allowing power feed to be done.

In this case, the magnetic fluxes generated at the primary coil 110 are received by the secondary coil 102, and converted into electric power by electromagnetic induction so as to be transmitted to the circuit section 2. A closed magnetic circuit is formed so that the magnetic fluxes generated at the primary coil 110 convergently pass through the center core 112 and interlink with the secondary coil 102. Thus, power transmission to the secondary coil 102 is achieved with high efficiency. Besides, since the action of making the magnetic fluxes converged on and interlinked with the secondary coil 102 is performed by the center core 112 included in the power-feeding unit 118, the ring sensor 101 does not need the core, hence being lightweight.

With such a construction as shown above, since electric power can be transmitted in a noncontact manner from the power-feeding unit 118 to the ring sensor 101, which is a power-fed unit, the need for electric contacts is eliminated, so that the ring sensor 101 can be provided in a waterproof structure.

Also, by the provision of the pillar 114, the area of the portion at which the inner circumferential surface of the cylindrical portion 111 and the outer circumferential surface of the pillar 114 are in contact with each other is increased.

Also, by the provision of the recessed portion 116, the area of the portion at which the center core 112 and the pillar 114 are in contact with each other is increased.

A portion at which cores are in contact with each other becomes an air gap, involving an increase in magnetic reluctance and incurring a decrease in power transmission efficiency. Therefore, it is preferable that the air gap should be small in thickness and the area of the contact portion large in area. Thus, with the configuration of this embodiment, the magnetic reluctance is decreased and the power transmission efficiency is improved.

Also, the opening and the lid portion 113 have mutually fittable shapes, facilitating their positional alignment.

Also, by virtue of the truncated-cone shape of the center core 112, a single power-feeding unit will do for power feed to ring sensors having different inner diameters. Therefore, power feed can be performed even if the ring sensor 101 is engaged at any point on the center core 112.

Also, as shown in FIG. 1C, it is also possible that the secondary coil 102 is composed of first and second secondary coils 102a and 102b which are wound around independently of each other so as to feed power to first and second independent loads 109a and 109b, respectively.

In this case, since the electric coupling between the first and second loads 109a and 109b can be weakened, it becomes possible to suppress, for example, variations of the second load 109b due to variations of the first load 109a.

Further, by setting different numbers of winding, different voltages can be extracted. This is effective for the case, for example, where the first load 109a and the second load 109b, which are secondary batteries of mutually different voltages, are charged.

In addition, the secondary coil is not necessarily limited to two in number, and may be provided in plural numbers.

Also, since a high-frequency current flows through the secondary coil 102, a plurality of secondary coils may be provided and connected in parallel to one another with a view to reducing losses due to the skin effect. Further, a litz wire made by preliminarily stranding mutually insulated conductive wires may be wound around to form the secondary coil 102.

### Embodiment 2

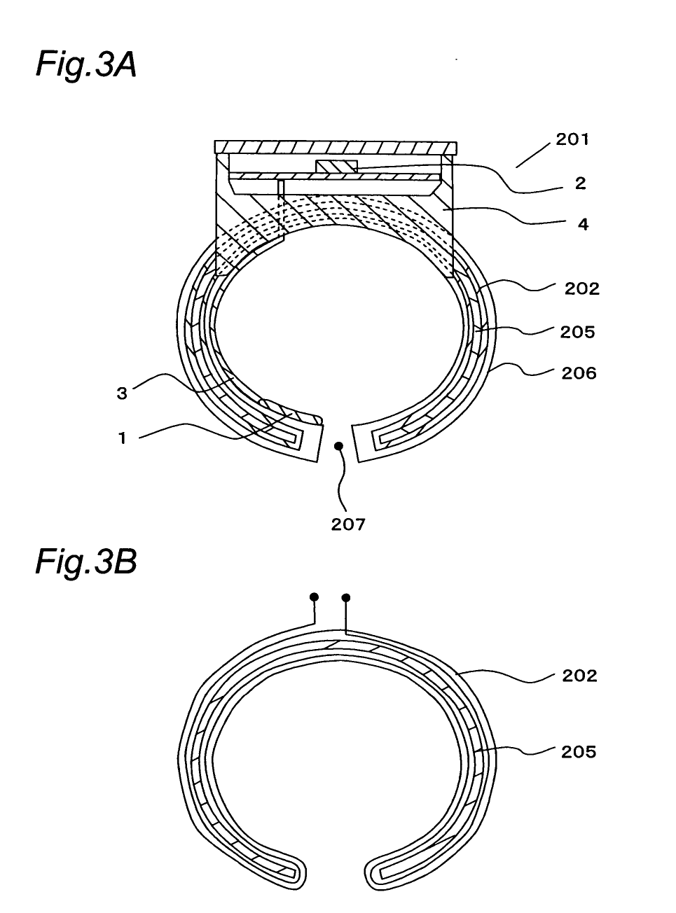

FIG. 3A is a sectional view of a ring sensor according to Embodiment 2. FIG. 3B is a sectional view in which only a secondary coil of the ring sensor and a power-fed side core are shown. Among the components according to this embodiment, the same components as those of Embodiment 1 shown in FIGS. 1 and 2 are omitted in description and, mainly, differences are explained below.

A ring sensor 201 is composed of a horseshoe ring-shaped belt 206 having a discontinuous portion 207, and a housing section 4 provided on the outer periphery of the belt 206.

A horseshoe power-fed side core 205 is contained inside the belt 206. Further, a secondary coil 202 is wound along the outer configuration of the horseshoe cross section of the power-fed side core 205.

The power-fed side core 205 may also be formed so as to be flexible by stacking surface-insulated amorphous sheet metal or other magnetic materials into multiple layers.

Otherwise, the power-fed side core 205 may also be molded flexible by dispersing magnetic powder into resin.

Otherwise, the power-fed side core 205 may also be molded flexible by resin with magnetic material small pieces arrayed in a plurality.

The power-fed side core 205 formed in this way has flexibility, so that when the ring sensor 201 with the power-fed side core 205 mounted thereon is fitted to the finger, a good feeling of fitness results. Besides, the horseshoe shape allows the ring sensor 201 to be fitted to different sizes of a user's fingers easily. Further, the finger is pressed tight by elasticity of the power-fed side core 205 or the belt 206 tighten, so that the detection section 1 can be pressed against a measurement site. It is noted that the insulation of the sheet metal surface is intended to reduce any losses due to eddy currents.

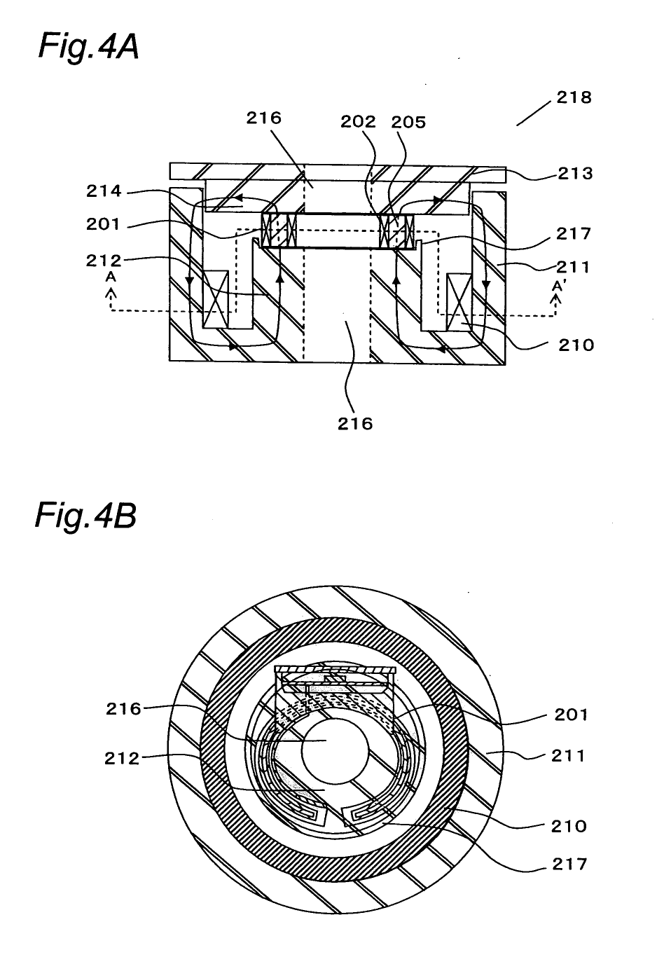

FIG. 4A is a sectional view of a power transmission part of a power-feeding unit according to Embodiment 2. FIG. 4B is a sectional view taken along the line A-A′ of FIG. 4A.

A power-feeding unit 218 is composed of a power-feeding side core, and a primary coil 210 wound around the power-feeding side core.

The power-feeding side core is composed of a cylindrical portion 211 which has one end opened and which is formed into a bottomed cylindrical shape, a center core 212 protruding at a bottom-portion center of the cylindrical portion 211, a lid portion 213 which closes the opening, and a pillar 214 protruding at a generally central portion of the lid portion 213.

An outer diameter of the center core 212 is larger than an outer diameter of the belt 206 of the ring sensor 201.

A height of the center core 212 is so designed that a sum of the height of the center core 212 and a thickness of the ring sensor 201 becomes smaller than a height of the inner wall of the cylindrical portion 211.

Also, the pillar 214 is fitted to the opening of the cylindrical portion 211, and has its outer circumferential surface brought into contact with the inner circumferential surface of the cylindrical portion 211.

A height of the pillar 214 is so designed that a sum of the height of the center core 212, the thickness of the ring sensor 201 and the height of the pillar 214 becomes equal to or larger than the height of the inner wall of the cylindrical portion 211.

The primary coil 210 is wound along inner circumferential surface at the bottom of the cylindrical portion 211 so as to be concentric with the center core 212.

In the power-feeding unit constructed as shown above, the ring sensor 201 is placed on the upper end surface of the center core 212, and the opening is closed by setting the lid portion 213 thereon. Thus, a closed magnetic circuit including the power-fed side core 205 of the ring sensor 201 such as indicated by arrow in the figure is formed, allowing power feed to be done.

In this case, even if the ring sensor 201 is discontinuous ring-shaped like a horseshoe shape, a closed magnetic circuit is formed so that the magnetic fluxes generated at the primary coil 210 pass through a core 205 of the ring sensor 201 and interlink with the secondary coil 202. Thus, power transmission to the secondary coil 202 is achieved with high efficiency.

In addition, the amount of transmitted electric power depends on the number of magnetic fluxes interlinking with the secondary coil 202, and the magnetic fluxes pass through so as to be converged on the core. Therefore, it is preferable that the number of turns of the secondary coil 202 is larger, and that the cross-sectional area of the power-fed side core 205 is larger.

With the dimensions of the power-feeding side core designed as shown above, even if a ring sensor having a different thickness is mounted, the inner circumferential surface of the cylindrical portion 211 and the outer circumferential surface of the pillar 214 are in contact with each other at all times. Also, the lower end surface of the pillar 214 and the power-fed side core 205 are in contact with each other at all times. Thus, a closed magnetic circuit is formed stably at all times.

Furthermore, a fitting portion 217 formed by making an outer circumferential portion of the center core 212 swollen is provided on the upper end surface of the center core 212. This facilitates such an alignment that the secondary coil 202 is accommodated and placed within an end face region of the center core 212.

Also, a hollow portion 216 whose diameter is smaller than an inner diameter of the secondary coil 202 is provided in at least either one of the center core 212 or the pillar 214. This eliminates the core for part other than the closed magnetic circuit, i.e., part that does not contribute to power transmission, which allows the core to be reduced in weight. The hollow portion 216, which is provided with a view to reducing the weight of the core, may be formed into a recessed portion or other lightening shape.

### Embodiment 3

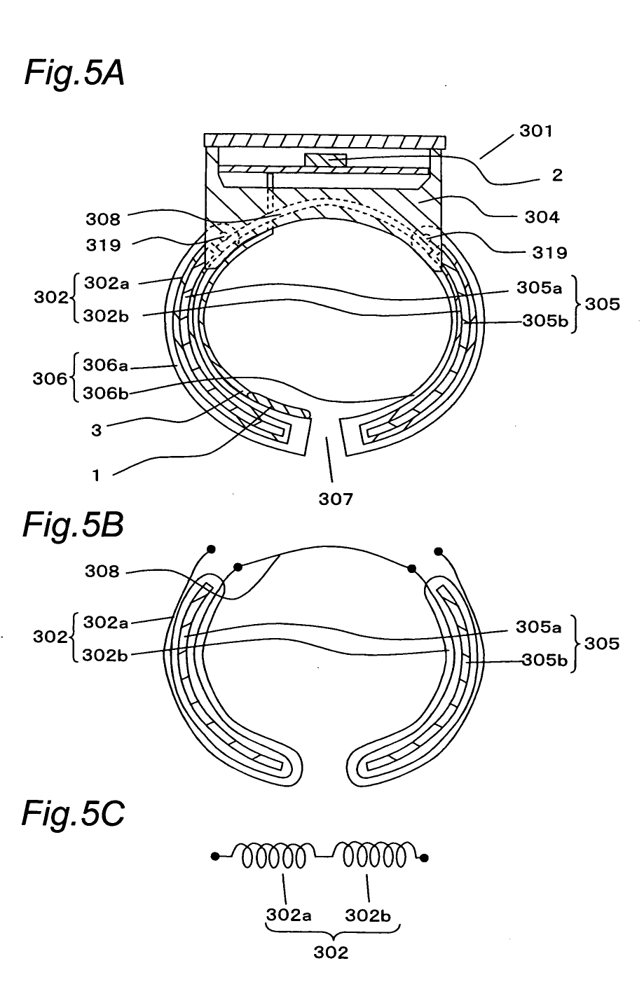

FIG. 5A is a sectional view of a ring sensor according to Embodiment 3. FIG. 5B is a sectional view in which only a secondary coil and a power-fed side core are shown. FIG. 5C is a circuit diagram.

A ring sensor 301 is composed of a housing section 304, and first leg portion 306a and second leg portion 306b provided at one end and the other end, respectively, of the housing section 304.

Coupling portions 319 are provided at one end and the other end of the housing section 304, respectively. To these one end and the other end, one ends of the first and second leg portions 306a and 306b, respectively, are coupled at the coupling portions 319 so as to be rotatable about a rotational axis, thus forming a horseshoe ring shape as a whole.

In this case, since the opening angle of the leg portions 306 is freely adjustable, the ring sensor is suitable for fitting to users' fingers of different thicknesses.

Inside the casing of the first leg portion 306a, is contained an arched first core 305a which is a power-fed side core. A first secondary coil 302a is further wound along the outer shape of the arched cross section of the core 305a. Similarly, the second leg portion 306b is formed. These secondary coils are electrically and structurally connected to each other in series flexibly by a flexible board 308 so as to obtain a single output.

Even in the case where the secondary coils 302 are provided separate to each other, these secondary coils can be connected to each other flexibly by the flexible board 308.

It is also possible that two leg portions are formed flexibly by the method described in Embodiment 2, and bonded to one end and the other end of the housing section 304, respectively. In this case also, a ring in which the opening angle of the leg portions is freely adjustable can be made up.

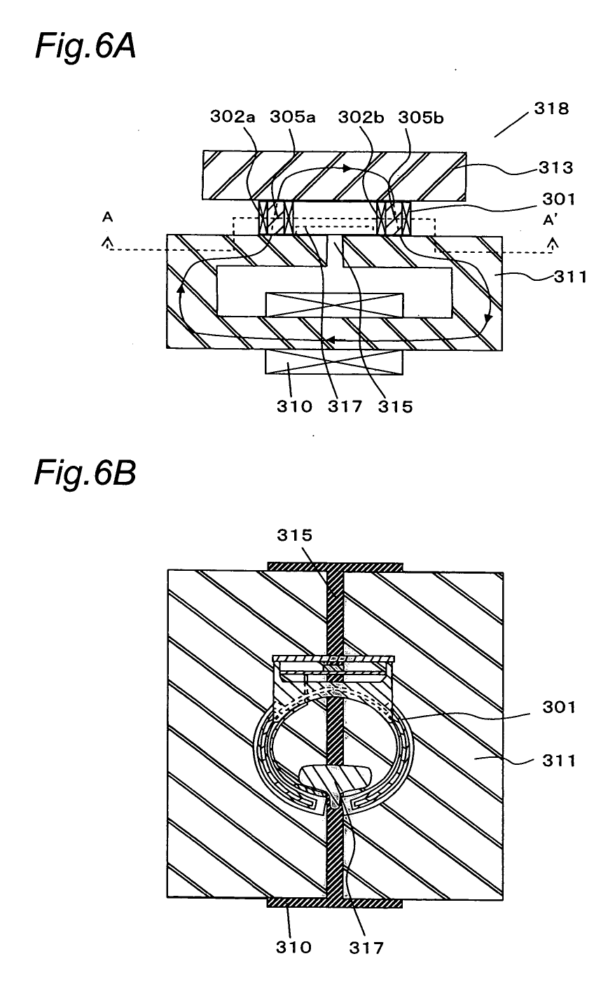

FIG. 6A is a sectional view of a power transmission part of a power-feeding unit according to Embodiment 3. FIG. 6B is a sectional view taken along the line A-A′ of FIG. 6A.

A power-feeding unit 318 is composed of a power-feeding side core, and a primary coil wound around the power-feeding side core.

The power-feeding side core is composed of a rectangular-cylindrical core 311 and a lid portion 313.

The rectangular-cylindrical core 311 has, in one face of its outer wall, a gap 315 parallel to the axial direction of the rectangular cylinder. Further, on the counter side to the gap 315, a primary coil 310 is wound around a bottom portion of the rectangular-cylindrical core 311 in this embodiment. A surface of the rectangular-cylindrical core 311 having the gap 315 is used as the placement surface, and the ring sensor 301 is placed on the surface. In this case, there is a positional relation that the first core 305a of the ring sensor 301 is brought into contact with one of the placement surface divided by the gap 315 while a second core 305b is brought into contact with the other of the placement surface. Furthermore, a closed magnetic circuit such as indicated by arrow in the figure is formed when the lid portion 313 is placed so as to bridge the first core 305a and the second core 305b.

In this case, a closed magnetic circuit is formed so that the magnetic fluxes generated at the primary coil 310 pass through the cores 305 of the ring sensor 301 and interlink with the secondary coil 302. Thus, power transmission to the secondary coil 302 is achieved with high efficiency.

It is noted that the distance of the gap 315 provided in the placement surface is, preferably, so designed as to be larger than zero and smaller than the distance of a discontinuous portion 307 of the ring sensor 301, being, for example, a few millimeters or so.

In short, it is essentially appropriate that the magnetic fluxes generated in the power-feeding unit 318 pass through the cores 305 of the ring sensor 301 and the lid portion 313 so as to lead from the one placement surface to the other placement surface. That is, it is appropriate that the gap 315 is provided to make magnetic reluctance increased at that portion to block the passage of the magnetic fluxes.

Furthermore, it is necessary that the gap 315 of the power-feeding unit 318 and the discontinuous portion 307 of the ring sensor 301 are placed so as to be coincident in position with each other. A fitting portion 317 is provided in the placement surface so that the placement state as described above can be easily obtained.

When the cores 305 of the power-fed unit bridge the gap 315, a closed magnetic circuit is formed at this portion. In this case, there is a problem that the number of magnetic fluxes interlinking with the secondary coils 302 is decreased, causing the power transmission efficiency to lower. Therefore, providing the fitting portion 317 makes it possible to avoid such a problem.

### Embodiment 4

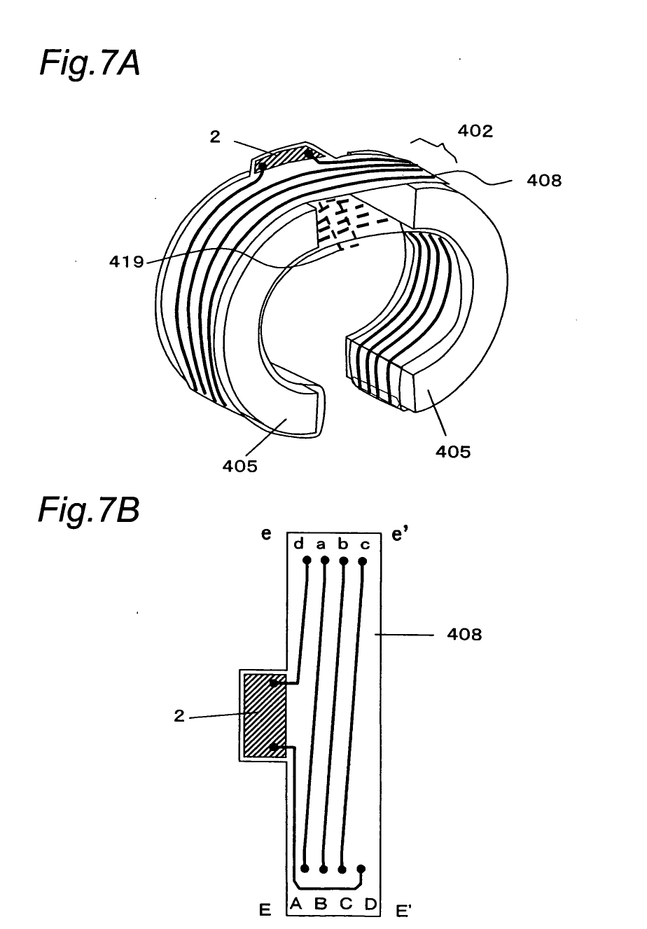

FIG. 7A is a perspective view in which a flexible board is provided circumferentially on a core of a ring sensor according to Embodiment 4. FIG. 7B is a plan view of the flexible board.

A flexible board 408 is provided circumferentially on a power-fed unit core 405. On this flexible board 408, a secondary coil 402 and connecting wires connected to the circuit section 2 are formed integrally.

On the flexible board 408, which is, for example, strip-shaped as shown in the figure, conductors A-a to C-c parallel to the longitudinal direction, and conductors D and d connected to the circuit section 2 are formed. Further, terminal portions A to D are arrayed at one end E-E′ while terminal portions a to d are arrayed at the other end e-e′.

The flexible board 408 as shown above is provided circumferentially along the outer shape of the arched cross section of the power-fed unit core 405, and the one end E-E′ and the other end e-e′ are coupled together at a junction portion 419. The terminal portions A and d, B and a, C and b, and D and c are electrically connected to each other, respectively, by which the secondary coil 402 is formed.

The secondary coil formed in this way is flexible as a whole, thus suitable for cases where the power-fed side core has a movable part.

With this structure, the secondary coil 402 is formed only by circumferentially providing the flexible board 408 on the power-fed unit core 405 instead of winding a conductive wire around thereon, thus being convenient to manufacture.

Further, the structure may be that the number of parallel conductors is increased, or that the number of turns is increased with the use of a flexible board having multilayered wiring.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A power feed system for feeding power by electromagnetic coupling of a primary coil of a power-feeding unit and a secondary coil of a power-fed unit, wherein
the power feed system is a noncontact power feed system in which the power-feeding unit and the power-fed unit are separable from each other, and
the power-feeding unit includes a power-feeding side core which is composed so as to be separable.

2. The power feed system as claimed in claim 1, wherein the power-feeding side core comprises:
a cylindrical portion which has an opening at its one end and which is formed into a bottomed cylindrical shape larger than an outer diameter of the primary coil;
a center core protruding at a bottom-portion center of the cylindrical portion, and a lid portion for closing the opening, wherein
the primary coil is wound so as to be concentric with the center core, and
the secondary coil is inserted into the center core so that when the opening is closed by the lid portion, a closed magnetic circuit is formed.

3. The power feed system as claimed in claim 1, wherein the outer diameter of the center core decreases with increasing nearness to the opening so as to exhibit a truncated-cone shape.

4. The power feed system as claimed in claim 2, wherein a pillar protrudes at a generally central portion of the lid portion, the pillar being fitted to the opening, and
an outer circumferential surface of the pillar is brought into contact with an inner circumferential surface of the opening.

5. The power feed system as claimed in claim 4, wherein a recessed portion is provided at a generally central portion of the pillar, the recessed portion being fitted to an end portion of the center core, and
an inner circumferential surface of the recessed portion is brought into contact with the outer circumferential surface of the center core.

6. The power feed system as claimed in claim 1, wherein the power-feeding side core comprises a cylindrical portion which has an opening at its one end and which is formed into a bottomed cylindrical shape larger than an outer diameter of the primary coil, a center core protrudes at a bottom-portion center of the cylindrical portion, and a lid portion for closing the opening, wherein
the primary coil is wound so as to be concentric with the center core,
the power-fed unit is placed on an opening-side end face of the center core, and
when the opening is closed by the lid portion, a closed magnetic circuit is formed.

7. The power feed system as claimed in claim 6, wherein a pillar protrudes at a generally central portion of the lid portion, the pillar being fitted to the opening, and
an outer circumferential surface of the pillar is brought into contact with an inner circumferential surface of the opening.

8. The power feed system as claimed in claim 7, wherein a sum of a height of the center core and a thickness of the power-fed unit is smaller than an inner-wall height of the cylindrical portion, and
a sum of the height of the center core, the thickness of the power-fed unit and a height of the pillar
is equal to or larger than the inner-wall height of the cylindrical portion.

9. The power feed system as claimed in claim 6, further comprising a fitting portion which allows the secondary coil to be accommodated and placed within an end face region of the center core.

10. The power feed system as claimed in claim 6, wherein the power-fed unit includes a ring-shaped casing, and
at a generally central portion of at least either one of the center core or the pillar,
a hollow portion whose diameter is smaller than an inner diameter of the secondary coil is provided.

11. The power feed system as claimed in claim 1, wherein the power-feeding side core comprises
a rectangular-cylindrical portion having a placement plane divided into first and second placement planes by a gap, and
a lid portion to be placed on the power-fed unit placed on the placement plane, and wherein
the primary coil is wound around the gap,
the power-fed unit includes a power-fed side core,
the power-fed side core is divided into first and second cores by a discontinuous portion,
the first and second cores are placed in contact on the first and second placement planes, respectively, and
when the first and second cores are bridged by the lid portion, a closed magnetic circuit is formed.

12. The power feed system as claimed in claim 11, wherein a distance of the gap is smaller than a distance of the discontinuous portion.

13. The power feed system as claimed in claim 11, wherein a fitting portion at which the placement plane and the power-fed unit are to be fitted to each other is further included so that
the gap and the discontinuous portion become generally coincident in position with each other.

14. A power-fed unit comprising:
a continuous or discontinuous ring-shaped casing; and
a power-fed side core made of a ring-shaped magnetic material having a ring-shaped continuous secondary coil within the casing or a discontinuous portion, and
a secondary coil wound along an outer configuration of the power-fed side core.

15. The power-fed unit as claimed in claim 14, wherein the power-fed side core is flexible.

16. The power-fed unit as claimed in claim 14, wherein the power-fed side core is formed by stacking thin sheets of a magnetic material into multiple layers.

17. The power-fed unit as claimed in claim 14, wherein the power-fed side core is molded by dispersing magnetic powder into resin.

18. The power-fed unit as claimed in claim 14, wherein the secondary coil is composed of a plurality of coils in combination.

19. The power-fed unit as claimed in claim 18, wherein the secondary coils are connected so as to feed power to loads independent of one another, respectively.

20. The power-fed unit as claimed in claim 14, wherein a flexible board is connected to the secondary coil.

21. The power-fed unit as claimed in claim 20, wherein the entire secondary coil is formed from a flexible board.

22. The power-fed unit as claimed in claim 21, wherein the flexible board includes a plurality of conductors placed generally parallel to the flexible board,
the conductors extend from one end to the other of the flexible board, and
one end of one conductor and the other end of the other conductor are electrically connected to each other, by which the secondary coil is formed.

23. A noncontact power feed system which is enabled to feed power in a state that the power-fed unit as claimed in claim 14 is placed on
the power-feeding unit as claimed in claim 1.

24. A ring sensor on which the power-fed unit as claimed in claim 14 is mounted.

25. A ring sensor in which the ring sensor as claimed in claim 24 is combined with
the power-feeding unit as claimed in claim 1.
